(19) United States
(12) Patent Application Publication
(10) Pub. No.: US 2017/0043614 A1
(43) Pub. Date: Feb. 16, 2017

(54) MULTI-PIECE DECAL SYSTEM AND METHODS

(71) Applicant: John Gleneicki, Mission Viejo, CA (US)

(72) Inventor: John Gleneicki, Mission Viejo, CA (US)

(21) Appl. No.: 15/334,597

(22) Filed: Oct. 26, 2016

Related U.S. Application Data
(63) Continuation-in-part of application No. 14/121,055, filed on Jul. 28, 2014, now abandoned.
(60) Provisional application No. 61/857,339, filed on Jul. 23, 2013.

(51) Int. Cl. B44C 3/12; B32B 37/18; B32B 37/12

(52) U.S. Cl. CPC B44C 3/12; B32B 37/12; B32B 37/182; B32B 2451/00

(57) ABSTRACT

A multi-piece decal system for changing an appearance of a surface of an object, having a set of decal pieces, the set of decal pieces having a top side having a decorative design, and a bottom side having an adhesive, and a number of cutouts equal with the number of components associated with the surface of the object, wherein the set's outer contour matches the surface's outer contour, such that application of the set of decal pieces to the surface of the object can be accomplished without removal of any of the components associated with the surface of the object, and such that no cuts are needed on any of the decal pieces during the application of the set of decal pieces to the surface of the object.

### CROSS-REFERENCE TO RELATED APPLICATIONS

This application is a continuation-in-part of U.S. Non-Provisional Application No. 14/121,055, filed Jul. 28, 2014, which claims the benefit of U.S. Provisional Application No. 61/857,339, filed Jul. 23, 2013, and is hereby incorporated by reference, to the extent that it is not conflicting with the present application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

1. Field of the Invention

The invention relates generally to decals, and more specifically to the application of decals to stringed instruments and skateboards.

2. Description of the Related Art

In order to refinish, change the look of, or decorate a stringed instrument such as a guitar, bass, violin, cello, and so on, or a skateboard from its existing look or finish, a user must remove all of the parts to repaint the instrument or apply a one-piece decal. When decals are applied, if the decal is provided as a rectangle, the decal must be cut by the user to fit around all openings and cavities of the instrument. Once the decal application is complete, then all the parts of the instrument or skateboard must be replaced. Users inexperienced or unfamiliar with disassembling and reassembling a stringed instrument may be unable to complete these tasks themselves, or may disassemble or reassemble the instrument or skateboard incorrectly, or may damage their instrument or skateboard in the process. This process may be time-consuming and with a high risk of damaging the instrument or skateboard even for users experienced with disassembling and reassembling an instrument or skateboard. Therefore, there is a need for users to be able to quickly, easily, and safely change the look of their instrument or skateboard without the removal of any parts.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect a decal application system having multiple decals or skins with pre-cut holes is provided, wherein the multiple pieces may be placed around the various parts of a stringed instrument, and fitted together. Thus, an advantage is that no parts need to be removed from the instrument to apply a full decal, and the user does not need to trim the decal to fit their instrument. Another advantage is that a user may quickly and easily change the appearance of their instrument without assistance. Another advantage is that a user may use the system to fully cover the instrument with a decal and have a cost-effective way to mimic the look of an instrument having a more expensive finish. Another advantage is that the decal system is easy to remove, thus the appearance of the instrument can be changed quickly and often.

In another aspect a decal application system having multiple decals or skins with pre-cut holes is provided, wherein the multiple pieces may be placed around the various parts of a skateboard, and fitted together. Thus, an advantage is that the wheels and base of the skateboard do not need to be removed to apply a full decal. Another advantage is that a user may quickly and easily change the appearance of their skateboard without assistance.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the top perspective view of an exemplary guitar that may be decorated with a multi-piece decal system, according to an aspect.

FIG. 2 illustrates step 1 of an exemplary method of using a multi-piece decal system, showing the top perspective view of placing a first decal piece on the guitar, according to an aspect.

FIG. 3 illustrates step 2 of an exemplary method, showing the top perspective view of applying the first decal piece by pressing it down onto the guitar, according to an aspect.

FIG. 4 illustrates step 3 of an exemplary method, showing the top perspective view of applying the first decal piece by smoothing the first piece underneath the guitar strings, according to an aspect.

FIG. 5 illustrates step 4 of an exemplary method, showing the top perspective view of sliding the first decal piece underneath the guitar's fretboard, according to an aspect.

FIG. 6 illustrates step 5 of an exemplary method, showing the top perspective view of applying a second decal piece onto the guitar surface, according to an aspect.

FIG. 7 illustrates step 6 of an exemplary method, showing the top perspective view of applying the second decal piece by pressing it down on the guitar surface, according to an aspect.

FIG. 8 illustrates step 7 of an exemplary method, showing the top perspective view of smoothing out the second decal piece 802-b on the guitar surface, according to an aspect.

FIG. 9 illustrates the top perspective view of an exemplary guitar with the multi-piece decal system applied, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

For the following description, it can be assumed that most correspondingly labeled elements across the figures (e.g., 204 and 504, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

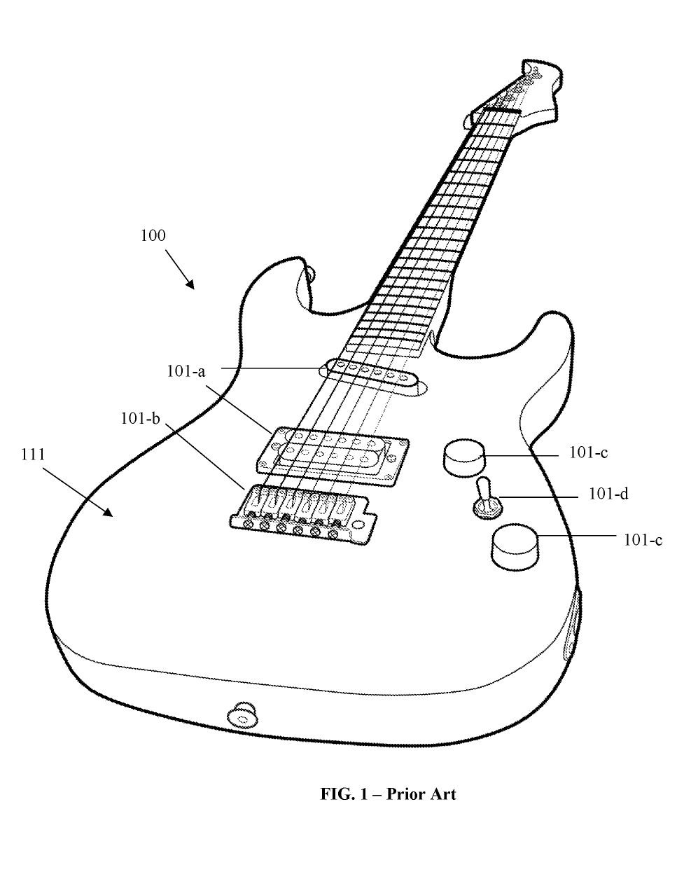

FIG. 1 illustrates the top perspective view of an exemplary guitar 100 that may be decorated with a multi-piece decal system (“multi-decal system,” “decal system,” “multi-decal system,” or “two-piece decal system”), according to an aspect. The exemplary guitar 100 shows parts such as pickups 101-a, a bridge 101-b, knobs 101-c, and a switch 101-d, such as a pickup selector switch. Parts such as the pickups 101-a and bridge 101-b may need to be removed when applying a traditional one-piece decal, or the decal would need to be custom cut by the user around some parts such as the knobs 101-c and switch 101-d. Using a multi-piece decal system, an entire top surface 111 of the guitar 100 may be fully covered without the need for removal of parts, and without the need for cutting the decal pieces during application.

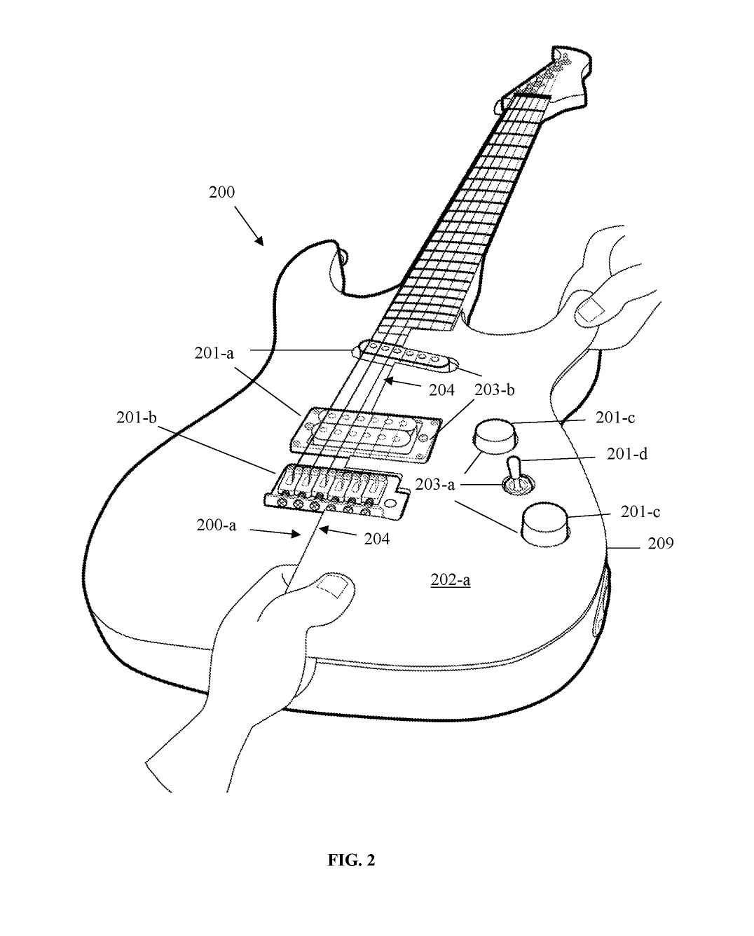

FIG. 2 illustrates step 1 of an exemplary method of using a multi-piece decal system, showing the top perspective view of placing a first decal piece 202-a (“first decal piece,” “first decal,” or “first piece,”) on the guitar 200, according to an aspect. The guitar 100 may be laid on a flat surface for decal application. Each piece of the multi-piece decal system may have cutouts, such as the pre-cut holes 203-a shown here and the notches 203-b along an edge of the first decal piece 202-a. The pre-cut holes 203-a of the first decal piece 202-a may be fitted around the knobs 201-c and switch 201-d, or any other components of the object to be decorated with the multi-piece decal system. The first decal piece 202-a may be aligned around the right edge 209 of the guitar. The center edge 204 of the first decal piece 202-a may be shaped to be contoured around the bridge and pickups, along the center line 200-a of the guitar 200 surface. As an example, a decal piece such as the first decal piece 202-a shown, having pre-cut holes, may be adhered first, due to the alignment of the holes to the guitar parts requiring more effort than aligning a decal piece without holes. The first decal piece 202-a may have a decorative design on a top side and may be adhered to the guitar 200 by a non-permanent adhesive provided on the bottom side. The decal pieces may be, for example, made of removable vinyl, such as a low-tack vinyl, or any other suitable material, such that a design may be applied, removed without leaving any residue, and reapplied at any time, while the vinyl or other material does not lose its shape or adhesiveness.

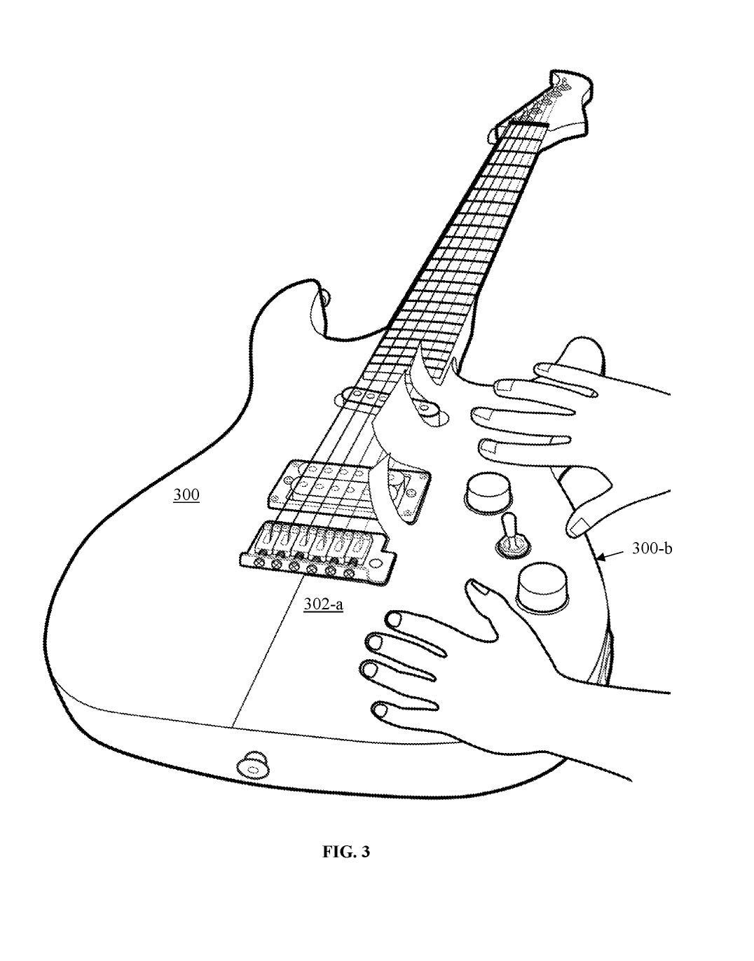

FIG. 3 illustrates step 2 of an exemplary method, showing the top perspective view of applying the first decal piece 302-a by pressing it down onto the guitar 300, according to an aspect. The portions of the first decal piece 302- adhering to the outer edge 300-b of the guitar 300 may be firmly pressed down first, as shown. Thus, the first decal piece may be fitted around the middle, length-wise, of the guitar 200, and cover a right side of the guitar 200.

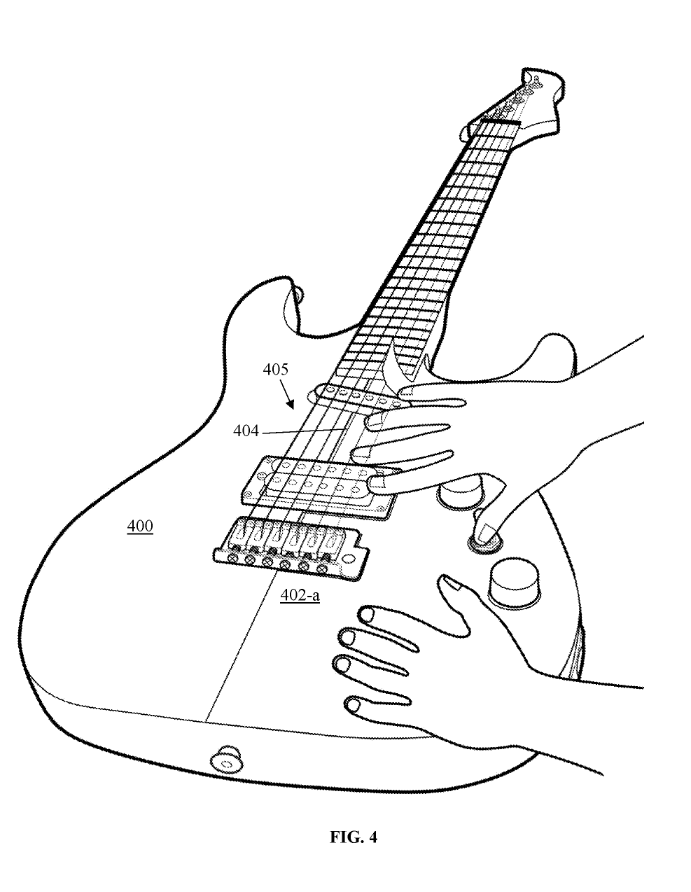

FIG. 4 illustrates step 3 of an exemplary method, showing the top perspective view of applying the first decal piece 402-a by smoothing the first piece 402-a underneath the guitar strings 405, according to an aspect. The center edge 404 of the first decal piece 402-a may be adhered to the surface of the guitar 400 underneath the strings 405 without the removal of any guitar parts.

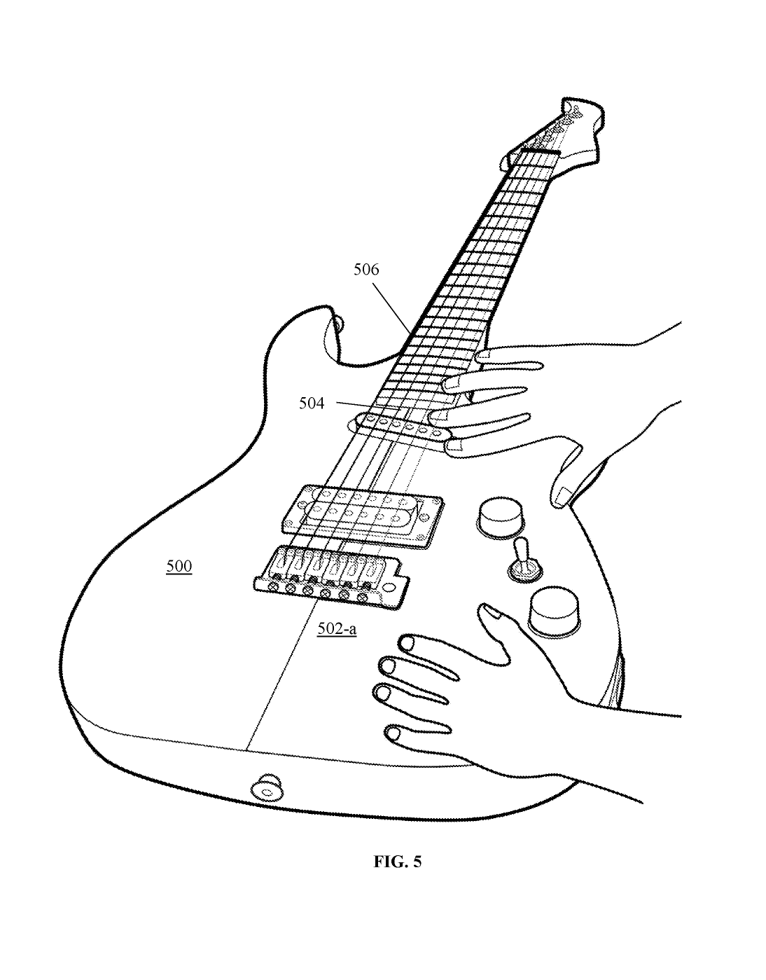

FIG. 5 illustrates step 4 of an exemplary method, showing the top perspective view of sliding the first decal piece 502-a underneath the guitar's fretboard 506, according to an aspect. Again, the center edge 504 of the first decal piece 502-a may be adhered to the surface for the guitar 500 underneath the fretboard 506 without the removal of any guitar parts. During the application of the first decal piece 502-a, if any bubbles or wrinkles appear underneath, the first decal piece may be lifted up and repositioned with one hand while smoothing the decal with the other hand. Thus, a single user may be able to apply the decal piece without assistance.

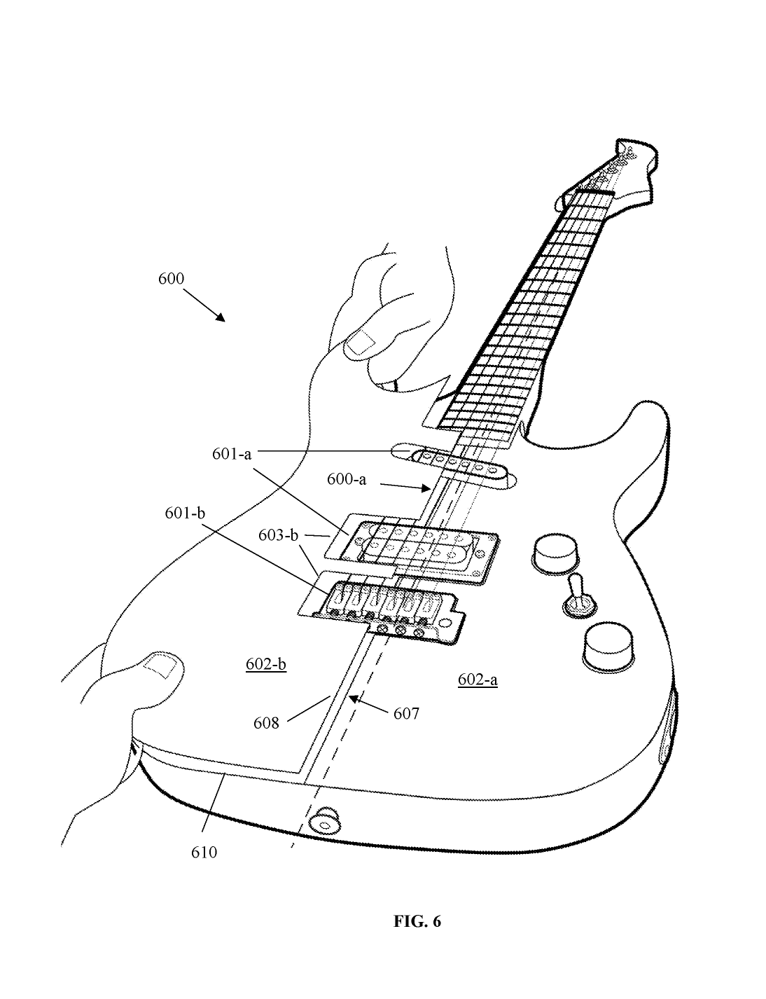

FIG. 6 illustrates step 5 of an exemplary method, showing the top perspective view of applying a second decal piece (“second decal piece,” “second piece,” or “second decal”) 602-b onto the guitar 600 surface, according to an aspect. The second decal piece may be shaped to align with a left outer edge 610 of the guitar 600. The center edge 608 of the second decal piece 602-b may, similarly to the first decal piece 602-a, be shaped to be contoured around the bridge 601-b and pickups 601-a by having cutouts such as notches 603-b, and applied along the center line 600-a of the guitar 600 surface. Again, similarly to the first decal piece 602-a, the second decal piece 602-b may have a decorative design on a top side and may be adhered to the guitar 600 by a non-permanent adhesive provided on the bottom side. The second 602-b decal piece may overlap over a section 607 of the first decal piece 602-a when applied, by approximately 1/4 of an inch, for example, in order to achieve a virtually seamless appearance when the multi-piece decal system application is complete.

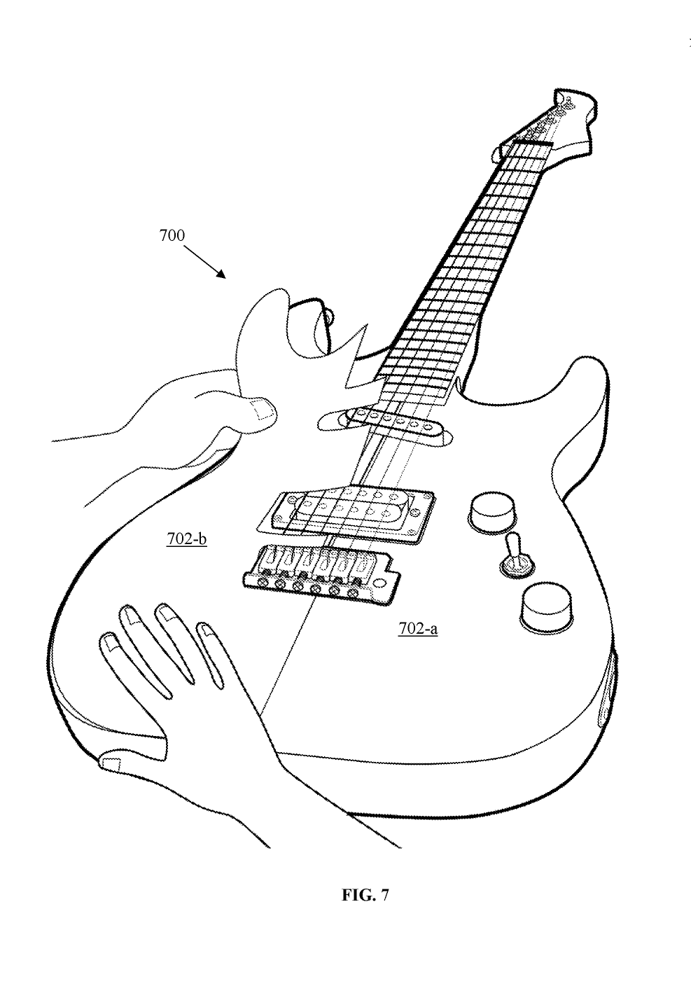

FIG. 7 illustrates step 6 of an exemplary method, showing the top perspective view of applying the second decal piece 702-b by pressing it down on the guitar 700 surface, according to an aspect. Once properly aligned with the guitar 700, the second decal piece 702-b may be pressed down and adhered to the guitar 700 surface.

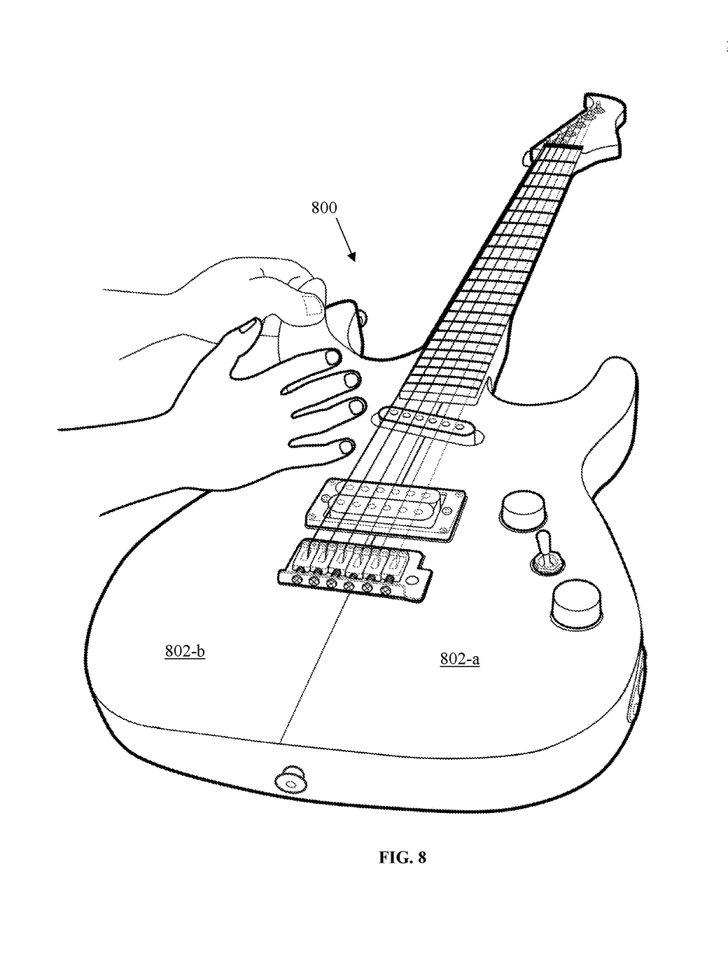

FIG. 8 illustrates step 7 of an exemplary method, showing the top perspective view of smoothing out the second decal piece 802-b on the guitar 800 surface, according to an aspect. Thus, the second decal piece 802-b may be fitted around the middle, length-wise, of the guitar 800, and cover a left side of the guitar 800.

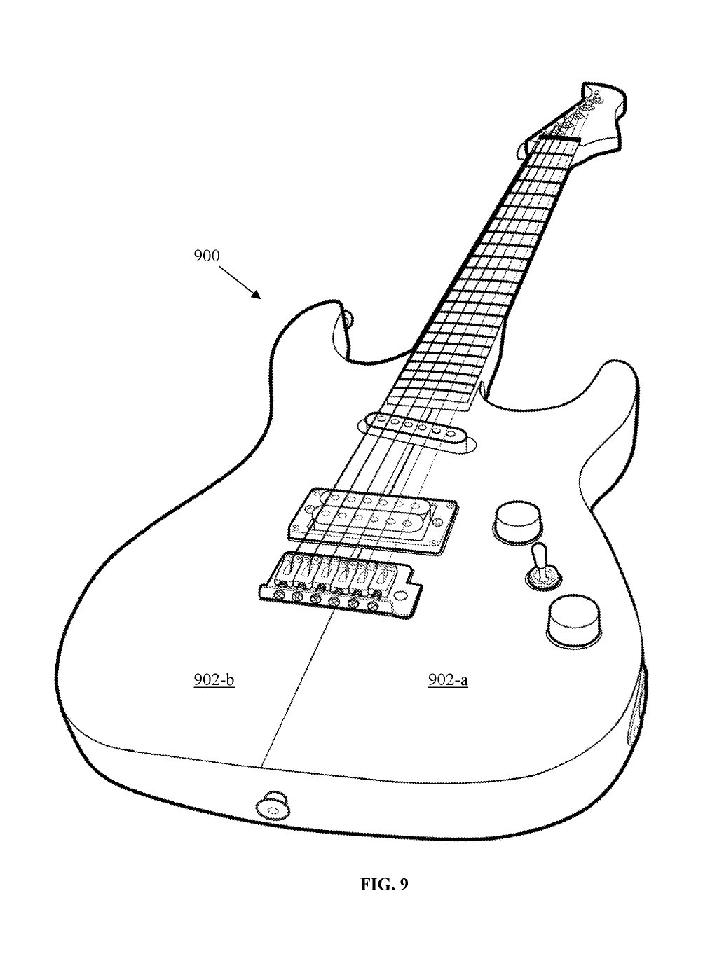

FIG. 9 illustrates the top perspective view of an exemplary guitar 900 with the multi-piece decal system applied, according to an aspect. The first decal piece 902-a and the second decal piece 902-b may completely cover the front of the guitar 900 and adhere to the guitar surface with a removable, non-permanent adhesive, such that the user may change the decorative decals on the guitar 900 as needed.

It should be understood that the multi-piece decal system described herein may also be used for a skateboard, such that the skateboard may be decorated without the need to remove the wheels or base from the skateboard deck. It should be understood that the multi-piece decal system may also be custom cut and used to decorate any other suitable surface, such as, for example, helmets, masks, and so on, and any other items that have parts that are hard to remove or are not removable.

A user may also create a multi-piece decal system for changing the appearance of an object by using, for example, a large format color printer, vinyl, and vinyl cutter. The user may print and cut a multi-piece decal system by first measuring the dimensions of the object to be decorated. If the object to be decorated is a standard model, such as, for example, a model of guitar or a skateboard, the user may obtain the exact dimensions, and then use the exact dimensions and vector drawings of the model of instrument, skateboard, or any other object to create a design to fit to those dimensions. The multi-piece decal system may be printed and cut with notches and may have a contoured shape to fit around the components on the surface of the object. The pieces of the decal system may also have holes to be placed around any components on the object to be decorated, such that the components may be placed through the holes without the need to remove the components. The user may also have the ability to place a decal around components or parts that are not removable. Thus, once the multi-piece decal system is created, no additional cuts need to be made on any of the decal pieces during application of the decal pieces to the object. Again, the decal pieces may have a removable adhesive on the bottom sides such that the decal pieces may be easily removed and reapplied.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A multi-piece decal system for changing an appearance of a surface of an object, comprising a set of decal pieces, the set of decal pieces having a top side having a decorative design, and a bottom side having an adhesive, and a number of cutouts equal with the number of components associated with the surface of the object, wherein the set's outer contour matches the surface's outer contour, such that application of the set of decal pieces to the surface of the object can be accomplished without removal of any of the components associated with the surface of the object, and such that no cuts are needed on any of the decal pieces during the application of the set of decal pieces to the surface of the object.

2. The multi-piece decal system of claim 1, wherein the cutouts comprise holes and notches.

3. The multi-piece decal system of claim 1, wherein the adhesive is configured to be removable and reapplied.

4. The multi-piece decal system of claim 3, wherein the set of decal pieces is constructed from low-tack vinyl.

5. The multi-piece decal system of claim 4, wherein the object is a musical instrument, and the set of decal pieces is configured to conform to dimensions of at least a standard musical instrument model, and the set of decal pieces cover a top surface of the guitar.

6. The multi-piece decal system of claim 5, wherein the musical instrument is a guitar. The multi-piece decal system of claim 1, wherein the object is a skateboard, and the set of decal pieces is configured to conform to dimensions of at least a standard skateboard model.

8. The multi-piece decal system of claim 6, wherein the set of decal pieces consists of a first decal piece and a second decal piece, and wherein the first decal piece covers a right side of the top surface of the guitar, and the second decal piece covers a left side of the top surface of the guitar.

9. The multi-piece decal system of claim 8, wherein the second decal piece overlaps with the first decal piece by about ¼^{th} of an inch.

10. A method of changing the appearance of a surface of an object using a multi-piece decal system comprising a set of decal pieces, the set of decal pieces having a top side having a decorative design, and a bottom side having an adhesive, and a number of cutouts equal with the number of components associated with the surface of the object, wherein the set's outer contour matches the surface's outer contour, such that application of the set of decal pieces to the surface of the object can be accomplished without removal of any of the components associated with the surface of the object, and such that no cuts are needed on any of the decal pieces during the application of the set of decal pieces to the surface of the object, the method comprising the steps of:
laying the object on a flat surface,
aligning a first decal piece of the set of decal pieces with a right edge of the object,
aligning at least one cutout in the first decal piece with at least one of the number of components associated with the surface of the object corresponding to the at least one cutout,
pressing the first decal piece down onto a right side of the surface of the object,
aligning the second decal piece with a left edge of the surface of the object, and pressing the second decal piece down onto a left side of the surface of the object.

11. The multi-piece decal system of claim 10, wherein the adhesive is configured to be removable and reapplied.

12. The method of claim 11, wherein the first decal piece and the second piece are constructed from low-tack vinyl.

13. The method of claim 9, wherein the object is a musical instrument, and the first decal piece and the second decal piece are configured to conform to dimensions of at least a standard musical instrument model.

14. The method of claim 9, wherein the object is a skateboard, and the first decal piece and the second decal piece are configured to conform to dimensions of at least a standard skateboard model.

15. A method of making a multi-piece decal system comprising a set of decal pieces, the set of decal pieces having a top side having a decorative design, and a bottom side having an adhesive, and a number of cutouts equal with the number of components associated with the surface of the object, wherein the set's outer contour matches the surface's outer contour, such that application of the set of decal pieces to the surface of the object can be accomplished without removal of any of the components associated with the surface of the object, and such that no cuts are needed on any of the decal pieces during the application of the set of decal pieces to the surface of the object, the method comprising the steps of:
measuring dimensions of the object,
creating a design,
printing the design on a material wherein the top side displays the decorative design and the bottom side has the adhesive,
cutting the material to conform to the dimensions of the object,
cutting a first decal piece to conform to a first portion of the object,
cutting a second decal piece to conform to a second portion the object, and
cutting the cutouts into the first decal piece and the second decal piece.

16. The method of claim 15, further comprising the steps of cutting a third decal piece to conform to a third portion of the object.

17. The multi-piece decal system of claim 15, wherein the cutouts comprise holes and notches.

18. The method of claim 15, wherein the adhesive is configured to be removable and reapplied.

19. The method of claim 18, wherein the material is low-tack vinyl.
